(19) United States
(12) Patent Application Publication
(10) Pub. No.: US 2026/0060396 A1
(43) Pub. Date: Mar. 5, 2026

(54) INFLATABLE MOBILE PHONE AND ACCESSORIES POUCH

(71) Applicant: Dongguan Polyfilm Plastic Products Company Limited, Guan City (CN)

(72) Inventors: Archer Tszkuen CHU, Guan City (CN); Hong Teng ZHOU, Guan City (CN)

(21) Appl. No.: 19/058,579

(22) Filed: Feb. 20, 2025

(30) Foreign Application Priority Data
Aug. 27, 2024 (CN) 2024111915421

(51) Int. Cl. A45C 11/00; A45C 13/00; A45C 13/10; A45F 5/00; B31B 70/66; B31B 150/00

(52) U.S. Cl. CPC A45C 11/002; A45C 13/002; A45C 13/103; A45F 5/1516; B31B 70/66; A45F 2005/006; A45F 2005/008; B31B 2150/00

(57) ABSTRACT

The invention relates to an inflatable pouch comprising an inflatable pouch with an interior pocket; an air valve attached to the inflatable body; a zipper configured to close an opening of the inflatable body; at least one clasp attached to the pouch; a rope connecting each clasps of the at least one clasp; a rope adjuster attached to the rope; and at least one ring attached to each clasp of the at least one clasp. The invention also relates to a method for creating an inflatable pouch.

### CROSS REFERENCE TO RELATED APPLICATIONS

The present application claims the benefit of priority to Chinese Application No. 2024111915421, filed on Aug. 27, 2024, the entire contents of which are incorporated herein by reference.

### FIELD

The present invention relates to an inflatable pouch designed to hold items including but not limited to a phone. The inflatable pouch is also configured to float due to air chambers within the pouch. The inflatable pouch is also configured as a protective measure to protect items inside the pouch.

### BACKGROUND

Existing pouches for phones and other items may provide protection for phones but may be inconvenient to carry due to size. Existing pouches may only be equipped to hold a phone and do not have the capacity to hold other items. The present invention provides an inflatable pouch to solve the above-mentioned problems.

### SUMMARY

The disclosed embodiments describe a pouch. In some embodiments, the pouch may include an inflatable body with an interior pocket, an air valve attached to the inflatable body, a zipper configured to close an opening of the inflatable body, at least one clasp attached to the pouch, a rope connecting each clasps of the at least one clasp, a rope adjuster attached to the rope, and at least one ring attached to each clasp of the at least one clasp.

In some embodiments, the air valve may be configured for inflating the inflatable body.

In some embodiments, the inflatable body may be a single chamber.

In some embodiments, the pouch may be comprised of weather-proof material.

In some embodiments, the rope may be detachable from the at least one clasp.

In some embodiments, the inflatable body may contain an air pathway for inflating the inflatable body.

In some embodiments, the air valve may include a seal to close the air valve.

In some embodiments, the pouch may be configured to float.

In some embodiments, the air valve may inflate the inflatable body by blowing air into the air valve.

The disclosed embodiments describe a method for creating an inflatable pouch. The method may include welding a rope to a body of the inflatable pouch, the body comprising a front panel, a back panel, and an air valve; welding an interior pocket to an interior of the body of the inflatable pouch; welding a zipper to an opening of the body; welding at least one top loop and at least one bottom loop to the body; and welding the front panel and the back panel together to form the body of the inflatable pouch. In some embodiments, the method may further include welding an air valve to the inflatable body.

In some embodiments, the method may further include welding four front pull straps and four back pull straps to the back panel.

In some embodiments, the method may further include welding the front pull straps and the back pull straps to the front panel to connect the back panel to the front panel.

In some embodiments, the front pull straps and the back pull straps may be configured to define a shape of the body.

In some embodiments, the method may further include welding a zipper reinforcement piece to the zipper.

In some embodiments, the method may further include welding the bottom loop to the body using a ring.

In some embodiments, the rope may be adjustable.

In some embodiments, the method may include using weather-proof material for the body.

The inventors additionally contemplate combining any of the above embodiments with one another.

The foregoing summarizes only a few aspects of the presently disclosed subject matter and is not intended to reflect the full scope of the presently disclosed subject matter as claimed. Additional features and advantages of the presently disclosed subject matter are set forth in the following description, may be apparent from the description, or may be learned by practicing the presently disclosed subject matter. Moreover, both the foregoing summary and following detailed description are exemplary and explanatory and are intended to provide further explanation of the presently disclosed subject matter as claimed.

The present invention describes an inflatable pouch designed to hold items. While inflatable pouches may have been designed to hold items, this inflatable pouch is designed to protect items held within the pouch and contains an air valve for use to inflate the pouch using air chambers. The ability to inflate the pouch using a single chamber may provide ease of use for a user, reduces bulk while providing protection for the items held in the pouch, and may provide better shape and structure for the pouch. In addition, the use of a single chamber may provide more convenient methods of product and be more efficient, thus reducing costs.

### BRIEF DESCRIPTION OF THE DRAWINGS

The accompanying drawings, which are incorporated in and constitute a part of this specification, illustrate multiple embodiments of the presently disclosed subject matter and, together with the description, serve to explain the principles of the presently disclosed subject matter; and, furthermore, are not intended in any manner to limit the scope of the presently disclosed subject matter.

FIG. 1A illustrates a perspective view of an inflatable pouch with an attached rope, according to some embodiments of the present disclosure.

FIG. 1B illustrates a back perspective view of an inflatable pouch, according to some embodiments of the present disclosure.

FIG. 1C illustrates a front sectional view of an inflatable pouch, according to some embodiments of the present disclosure.

FIG. 1D illustrates a front view of an inflatable pouch, according to some embodiments of the present disclosure.

FIGS. 2A-2B illustrate a front perspective view and a back perspective view, respectively, of an inflatable pouch, according to some embodiments of the present disclosure.

FIG. 3 illustrates a side view of an inflatable pouch with dimensions, according to some embodiments of the present disclosure.

FIGS. 4A-4B illustrate a front perspective view and a back perspective view, respectively, of an inflatable pouch with an attached rope, according to some embodiments of the present disclosure.

FIGS. 5A-5B illustrate a zipper on an inflatable pouch, according to some embodiments of the present disclosure.

FIG. 6A illustrates a logo tag on an inflatable pouch, according to some embodiments of the present disclosure.

FIG. 6B illustrates a rope and rope adjuster connected to an inflatable pouch, according to some embodiments of the present disclosure.

FIG. 7A illustrates a clasp with a loop, according to some embodiments of the present disclosure.

FIG. 7B illustrates a loop, according to some embodiments of the present disclosure.

FIG. 8 illustrates a method for creating an inflatable pouch, consistent with disclosed embodiments.

### DETAILED DESCRIPTION

Reference will now be made in detail to exemplary embodiments, some examples of which are shown in the accompanying drawings.

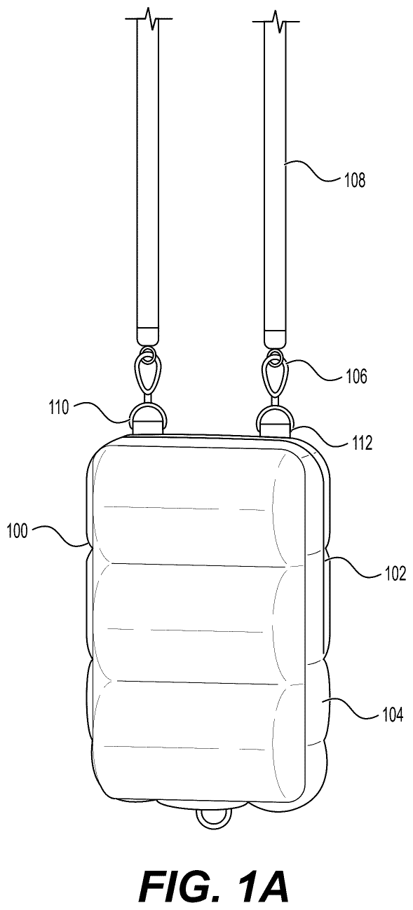

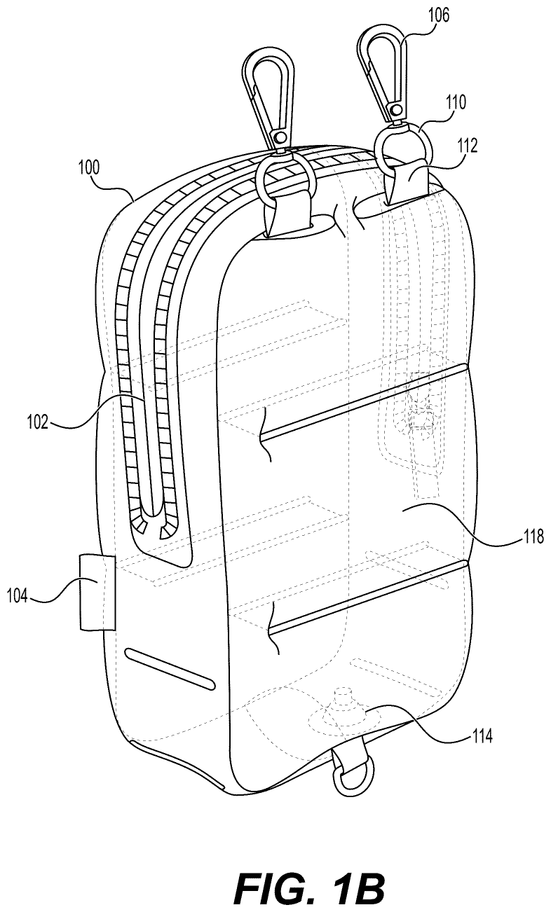

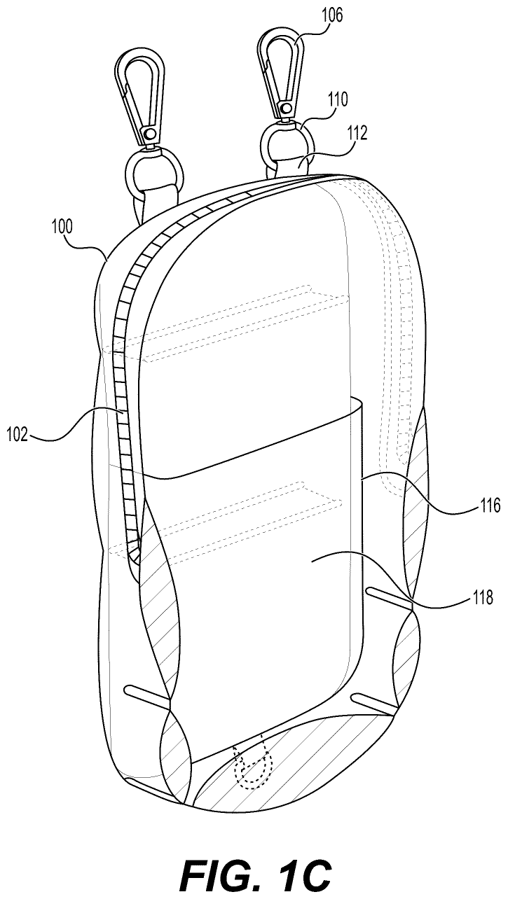

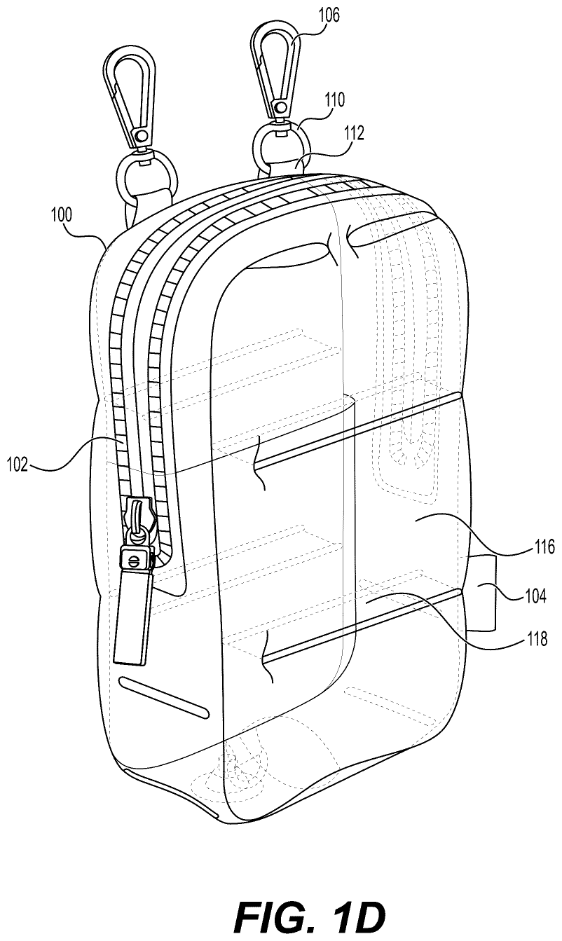

Exemplary disclosed embodiments include apparatuses, systems, and methods for using a pouch 100. Referring now to the figures, where like reference numerals represent like parts through the views, pouch 100 will be described in detail. FIG. 1A illustrates a perspective view of an inflatable pouch with an attached rope, according to some embodiments of the present disclosure.

Pouch 100 may include a zipper 102, a tag 104, a clasp 106, a rope 108, at least one ring 110 and at least one loop 112. In some embodiments, there may also be a ring 110 on the bottom of the pouch 100, as shown in FIG. 1A.

In some embodiments, the pouch 100 may be configured to protect a mobile phone or accessory when the mobile phone or accessory is located within the pouch. In some embodiments, pouch 100 may be constructed of plastic material. In some embodiments, the pouch material may be weather-proof to protect a mobile phone or accessory within the pouch from inclement weather, such as rain or snow. In some embodiments, pouch 100 may be constructed from polyvinyl chloride (PVC). In some embodiments, when zipper 102 is closed, pouch 100 may be sealed from water entry therein. In some embodiments, pouch 100 may not be fully waterproof.

In some embodiments, zipper 102 may have a metal, plastic, or other material pull tab that a user may use to open or close pouch 100. In other embodiments, zipper 102 may have a fabric attachment to the zipper that a user may pull on to open or close pouch 100. In some embodiments, zipper 102 may be constructed from PVC or polyester material or a combination of the two.

Tag 104 may be used as a brand logo to identify a manufacturer or company associated with pouch 100. In some embodiments, tag 104 may be constructed from PVC. In some embodiments, a brand logo may be printed on tag 104.

In some embodiments, clasp 106 may be made of metal material. In some embodiments, clasp 106 may be made of another material. In some embodiments, clasp 106 may have a spring-loaded gate that is used to connect components, such as to connect clasp 106 to ring 110 or rope 108. In other embodiments, clasp 106 may have a push clasp where the ends of the clasp push together, engaging a spring mechanism that holds the clasp closed until the clasp is pushed against.

In some embodiments, rope 108 may also include a rope adjuster (not pictured) to adjust the length of the rope. In some embodiments, the rope adjuster may be used to adjust the length of the rope to fit around, for example, a user's neck, or a user's wrist. In some embodiments, rope 108 may be constructed from a polyester material. In some embodiments, the rope adjuster may be constructed from a metal material.

In some embodiments, ring 110 may be connected to loop 112 as a way of connecting rope 108 to the pouch 100, consistent with disclosed embodiments. In other embodiments, a user may connect ring 110 to loop 112. In some embodiments, ring 110 may be constructed from metal material. In some embodiments, loop 112 may be constructed from a fabric, such as PVC.

In some embodiments, loop 112 may be welded to the pouch 100, consistent with disclosed embodiments. In embodiments with more than one loop 112, one or more loops 112 may be located on opposite sides of the pouch across from one another. In some embodiments, with more than one loop 112, one or more loops 112 may be located on the same side of the pouch.

FIG. 1B illustrates a back perspective view of an inflatable pouch, according to some embodiments of the present disclosure. Pouch 100 may include zipper 102, a tag 104, a clasp 106, a rope 108, at least one ring 110 and at least one loop 112, as described with respect to FIG. 1A. In some embodiments, pouch 100 may further include an air valve 114 and an inflatable chamber 118. To protect the contents within the pouch 100, the pouch 100 may include an inflatable chamber 118. The inflatable chamber 118 may be fluidly connected to air valve 114. In some embodiments, inflatable chamber 118 may include at least one air chamber. The air chamber may be connected the air valve 114. The inflatable chamber 118 may be located at side surfaces of the pouch 100, a front surface or a back surface of the pouch 100. By locating the inflatable chamber 118 around the pouch 100, the contents of the pouch 100 are protected. In some embodiments, the inflatable chamber 118 is a single chamber within the pouch. In some embodiments, using a single chamber rather than multiple chambers may reduce the bulkiness of the pouch and create a smaller volume. Reducing bulkiness may allow for more convenient production, reduce costs, and provide easier usability for a customer.

The inflatable chamber 118 may be inflated by air valve 114. In some embodiments air valve 114, may be located on a bottom surface of the pouch 100, as shown in FIG. 1B. In some embodiments, the air valve 114 may be a one-way valve. Specifically, the one-way valve may be a swing check valve where a movable part within the air valve 114 pivots either to block reverse flow or to allow forward flow. When in its open state, air valve 114 may fluidly connect an ambient environment to the inflatable chamber 118 of the pouch 100.

FIG. 1C illustrates a front sectional view of an inflatable pouch, according to some embodiments of the present disclosure. Pouch 100 may include zipper 102, a tag 104, a clasp 106, a rope 108, at least one ring 110 and at least one loop 112, as described with respect to FIG. 1A. In some embodiments, pouch 100 may further include an air valve 114 and an inflatable chamber 118, as described with respect to FIG. 1B. In some embodiments, pouch 100 may also include a pocket 116, as shown in FIG. 1C. Pocket 116 may be attached to the back of the pouch 100, as shown in FIG. 1C. In other embodiments, pocket 116 may be attached the front of the pouch 100 (not pictured). In some embodiments, pocket 116 may be configured to hold a standard size smartphone.

FIG. 1D illustrates a front view of an inflatable pouch, according to some embodiments of the present disclosure. Pouch 100 may include zipper 102, a tag 104, a clasp 106, a rope 108, at least one ring 110 and at least one loop 112, as described with respect to FIG. 1A. In some embodiments, pouch 100 may further include an air valve 114 and an inflatable chamber 118, as described with respect to FIG. 1B. In some embodiments, pouch 100 may also include a pocket 116, as described with respect to FIG. 1C. In some embodiments, pouch 100 may be configured to float.

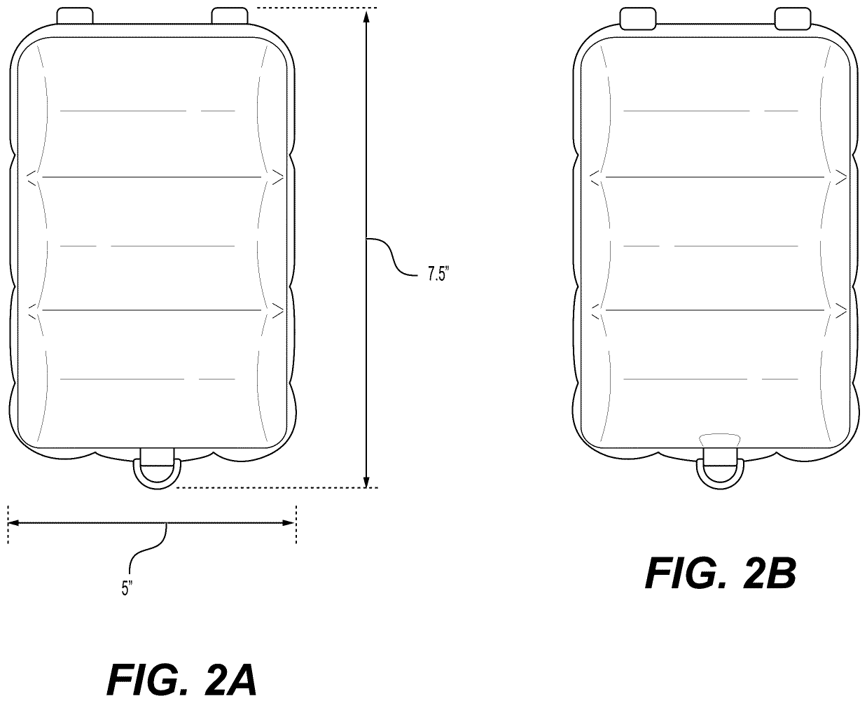

FIGS. 2A-2B illustrate front perspective views of an inflatable pouch, according to some embodiments of the present disclosure. FIG. 2A shows an exemplary measurement of the inflatable pouch, to illustrate that the pouch is able to hold phones of different sizes. FIG. 2B illustrates a view of the inflatable pouch without the rings and clasps, as described with respect to FIG. 1A. For example, a user may just wish to carry the pouch and not have it connected to a rope. In some embodiments, the rope may be detachable from the clasps to allow a user to just carry the pouch without the rope.

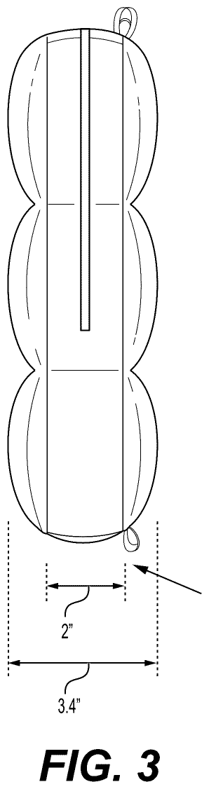

FIG. 3 illustrates a side view of an inflatable pouch with dimensions, according to some embodiments of the present disclosure. FIG. 3 illustrates how the pouch may be inflated using the air valve (not pictured) to obtain different dimensions, and can be deflated should a user need to fit the pouch into a smaller space. In some embodiments, the air valve may have a housing sealed to the pouch. In some embodiments, the air valve may be configured to inflate the inflatable body of the pouch. In some embodiments, the housing may have a valve that can be used to inflate the pouch. In some embodiments, the inflatable body may contain an air pathway used to inflate the inflatable body. In some embodiments, the air valve may have a cap or seal on it to seal the air valve when the pouch is inflated. In some embodiments, pressurized air may be used to inflate the pouch using, for example, an air pump, or a human mouth to inflate the pouch.

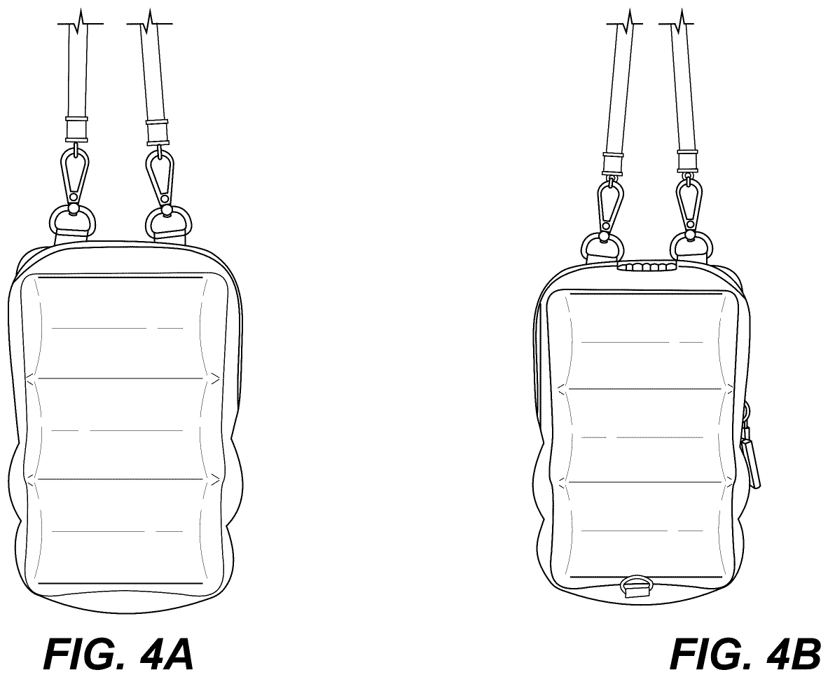

FIGS. 4A-4B illustrate a front perspective views of an inflatable pouch with an attached rope, according to some embodiments of the present disclosure.

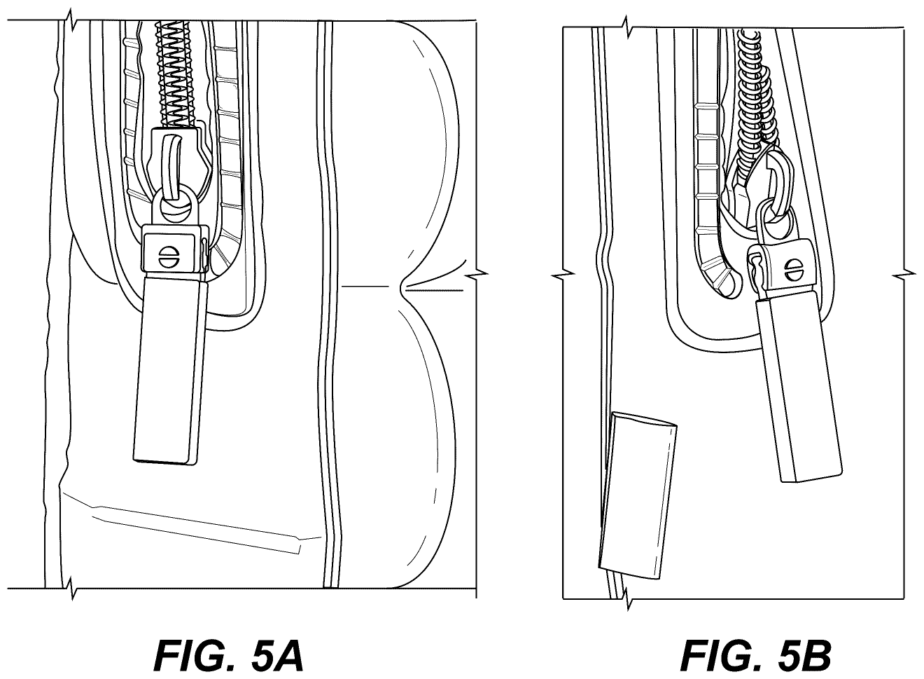

FIGS. 5A-5B illustrate a zipper on an inflatable pouch, according to some embodiments of the present disclosure. In some embodiments, the zipper may be made of a metal material. In some embodiments, the zipper may have a pull made of silicone, plastic, or fabric material that a user may use to pull the zipper open and closed.

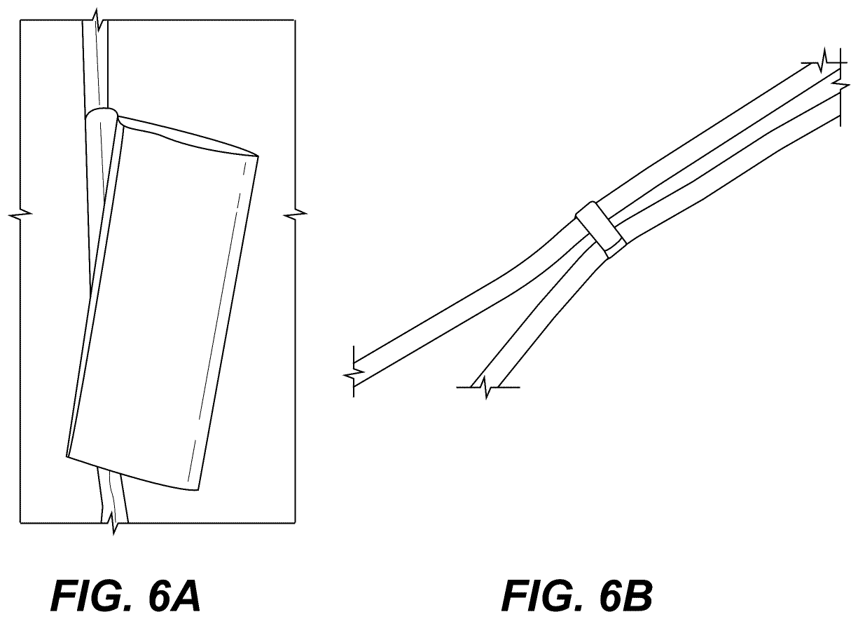

FIG. 6A illustrates a logo tag on an inflatable pouch, according to some embodiments of the present disclosure. In some embodiments, a logo may be printed on the logo tag. In some embodiments, the logo tag may be welded to the pouch, consistent with disclosed embodiments.

FIG. 6B illustrates a rope with a rope adjuster, where the rope may be connected to an inflatable pouch, according to some embodiments of the present disclosure.

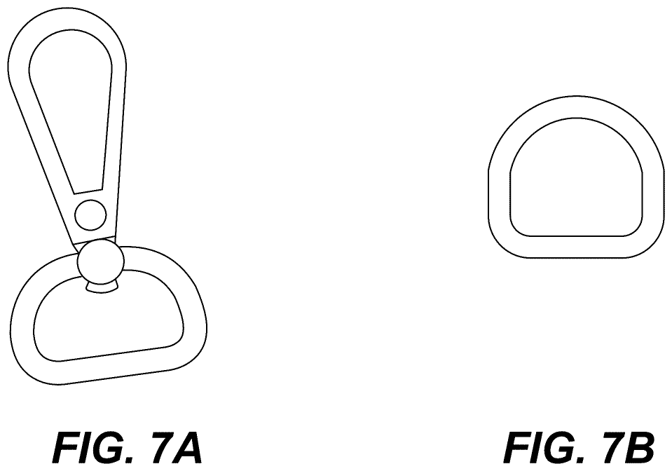

FIG. 7A illustrates a clasp with a loop, according to some embodiments of the present disclosure.

FIG. 7B illustrates a loop, according to some embodiments of the present disclosure.

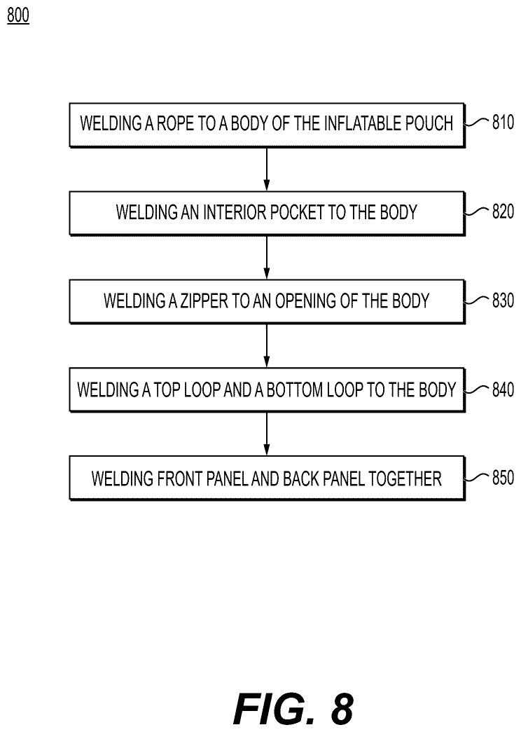

FIG. 8 illustrates a method for creating an inflatable pouch, consistent with disclosed embodiments. In some embodiments, the steps of process 800 may be perform using welding techniques, such as high-frequency welding. In some embodiments, high frequency welding may use high frequency electric fields to induce heating and melting of base materials, such as the materials described herein.

In some embodiments, process 800 at step 810 may include welding a rope to a body of an inflatable pouch. In some embodiments, the rope may be attached to a body of an inflatable pouch using casting. In some embodiments, the body may include a front panel and a back panel. In some embodiments, the body may be welded together by welding together the front panel and the back panel. In some embodiments, an air valve may be welded to the front panel. In some embodiments, an air valve may be welded to the body of the inflatable pouch.

In some embodiments, process 800 at step 820 may including welding an interior pocket to the body. In some embodiments, the interior pocket may be welded to the front panel. In other embodiments, the interior pocket may be welded to the back panel.

In some embodiments, process 800 at step 830 may include welding a zipper to an opening of the body. In some embodiments, at step 830 process 800 may also include welding a zipper reinforcement piece to the zipper.

In some embodiments, process 800 at step 840 may include welding at least one top loop and at least one bottom loop to the body. In some embodiments, the loop may be used to connect rings and clasps to a rope, consistent with disclosed embodiments. In some embodiments, the rope may have a rope adjuster, consistent with disclosed embodiments. In some embodiments, the rope is adjustable using the rope adjuster. In some embodiments, a rope may not be connected to the rings and clasps. In some embodiments, process 800 at step 850 may include welding a D ring to the body. In some embodiments, the D ring is welded to the bottom of the body. In some embodiments, process 800 at step 850 may include welding the front panel and back panel together to form the body of the inflatable pouch.

In some embodiments, the method may further include welding four front pull straps and four back pull straps to the back panel. The method may also include welding the front pull straps and the back pull straps to the front panel to connect the back panel to the front panel. In some embodiments, using the pull straps allows for configuration of a shape of the body of the pouch.

While the present disclosure has been described in connection with a plurality of exemplary aspects, as illustrated in the various figures and discussed above, it is understood that other similar aspects can be used or modifications and additions can be made to the described aspects for performing the same function of the present disclosure without deviating therefrom. For example, in various aspects of the disclosure, methods and compositions were described according to aspects of the presently disclosed subject matter. Additionally, other equivalent methods or composition to these described aspects are also contemplated by the teachings herein. Therefore, the present disclosure should not be limited to any single aspect, but rather construed in breadth and scope in accordance with the appended claims.

What is claimed is:

1. A pouch, comprising:
an inflatable body with an interior pocket;
an air valve attached to the inflatable body;
a zipper configured to close an opening of the inflatable body;
at least one clasp attached to the clasp;
a rope connecting each clasps of the at least one clasp;
a rope adjuster attached to the rope; and
at least one ring attached to each clasp of the at least one clasp.

2. The pouch of claim 1, wherein the air valve is configured for inflating the inflatable body.

3. The pouch of claim 1, wherein the inflatable body is a single chamber.

4. The pouch of claim 1, wherein the pouch is comprised of weather-proof material.

5. The pouch of claim 1, wherein the rope is detachable from the at least one clasp.

6. The pouch of claim 1, wherein the inflatable body contains an air pathway for inflating the inflatable body.

7. The pouch of claim 1, wherein the air valve comprises a seal to close the air valve.

8. The pouch of claim 1, wherein the pouch is configured to float.

9. The pouch of claim 1, wherein the air valve inflates the inflatable body through blowing into the air valve.

10. A method for creating an inflatable pouch, the method comprising:
welding a rope to a body of the inflatable pouch, the body comprising a front panel, a back panel, and an air valve;
welding an interior pocket to an interior of the body of the inflatable pouch;
welding a zipper to an opening of the body;
welding at least one top loop and at least one bottom loop to the body;
welding the front panel and the back panel together to form the body of the inflatable pouch.

11. The method of claim 10, wherein the operations further comprise welding an air valve to the inflatable body.

12. The method of claim 10, wherein the method further comprises:
welding four front pull straps and four back pull straps to the back panel.

13. The method of claim 12, wherein the method further comprises:
welding the front pull straps and the back pull straps to the front panel to connect the back panel to the front panel.

14. The method of claim 12, wherein the front pull straps and the back pull straps are further configured to define a shape of the body.

15. The method of claim 10, wherein the method further comprises welding a zipper reinforcement piece to the zipper.

16. The method of claim 10, wherein the method further comprises welding the bottom loop to the body using a ring.

17. The method of claim 10, wherein the rope is adjustable.

18. The method of claim 10, wherein the method further comprises using weather-proof material for the body.
